(19) United States
(12) Patent Application Publication
(10) Pub. No.: US 2002/0099552 A1
(43) Pub. Date: Jul. 25, 2002

(54) Annotating electronic information with audio clips

(76) Inventors: Darryl Rubin, Redmond, WA (US); Sheng Jiang, Bellevue, WA (US); Jonathan Cluts, Redmond, WA (US); Susan Woolf, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(21) Appl. No.: 09/768,813

(22) Filed: Jan. 25, 2001

(51) Int. Cl. G10L 21/00

(52) U.S. Cl. 704/270

(57) ABSTRACT

The present invention provides an audio recording/playback tool that is integrated with an information viewer that simplifies recording and playback of audio annotations. The invention also provides alternative techniques to retrieve, categorize and sort the audio annotations including the ability to associate audio annotations with either pages of a document or specific points inside a page. Further, the invention synchronizes audio playback and document navigation actions. The invention supports the storage of the audio annotations in a variety of formats including the annotations stored as discrete clips labeled with properties and stored in an external database that permits, among other things, exchanging of annotations between users.

### TECHNICAL FIELD

The present invention relates to annotation of electronic information displayed on an electronic display device, and more particularly, to annotation of electronic information displayed on an electronic display device through the use of audio clips.

### BACKGROUND OF THE INVENTION

Visual information surrounds us. Through the print media, the television, and the personal computer, users are presented with visual information having a variety of forms. In the electronic world, users primarily receive this information via personal computers and other electronic devices including personal data assistants (hereinafter referred to as PDAs) and electronic books. While reading, users may desire to annotate the visual information. In the print world, a user may simply jot notes in an article's margin. In the electronic world, a user may insert a comment into a document for later reference. An example of the electronic annotation feature includes the “comment” feature of Microsoft Word 97 (by the Microsoft Corporation of Redmond, Wash.).

Irrespective of the type of information (print or electronic), the annotation process is similar in technique and result. In some environments, however, textual annotations fall short of users' needs where audio information needs to be recorded in conjunction with the reading (or creating) of the textual information. A common solution is to use a mechanical tape recorder to receive oral comments from a user. Similarly, when taking notes, a student may use a mechanical tape recorder to record a professor's comments while taking notes. In both of these instances, the user has no simple way to associate the textual notes or document with the audio recorded on the tape.

In a related environment, some personal digital assistant devices offer the ability to record basic voice memos. However, there is no integration of the voice memos with displayed textual information.

### SUMMARY OF THE INVENTION

The present invention provides a virtual tape recorder that supports creating, storing, and listening to audio annotations similar to that of a traditional tape recorder using a moving magnetic tape. However, unlike a traditional tape recorder, the present invention operates in conjunction with displayed electronic information to provide an interactive reading experience. The present invention may be understood in three operation paradigms including creating audio annotations, playing back audio annotations, and sharing audio annotations with others.

First, a user may record audio annotations in a variety of ways. For example, a user may record audio annotations while paging through a document. A user may select record and start speaking independent of the displayed document. Also, while paging through the document, a user may begin speaking and have the recorded annotation automatically associated with the currently viewed page. Further, a user may highlight a word or location or object on a displayed document and begin speaking (with the recorded annotation being associated with the selected word, or location or object). With respect to these examples, this association may result in the display of an icon to alert a subsequent user to the presence of an audio annotation association with the page (or word or location or object on the page). The invention includes intelligent recording functions including, for example, automatic recording (where the system begins recording when it detects a user's voice and associates the created annotation with the currently viewed page or a selected portion of text, a displayed object, a word, or a document position).

Second, a user may play back the recorded audio in numerous ways. A user may play back the annotations by selecting an option that plays back all annotations independent of the viewed document. Also, the user may play back the audio annotations while the viewed document automatically tracks the playing annotations. The system includes intelligent playback options including automatic seeking (where a user pages through a document and the system seeks and plays the audio annotations associated with each page). Auto seek means a user is liberated from indexing a tape, during either playback or recording, as they navigate through a document or between documents.

In short, the invention provides users with an audio annotation recording/playback system that may be operated independent from and/or in conjunction with a document viewer. These operations may be achieved by storing and retrieving individual audio annotations in a database environment as compared to storing them as a single long annotation akin to a purely linear tape. When created, the audio annotations are associated with a number of properties. The properties allow a user to categorize, sort, and access the audio annotations in a variety of ways as definable by the user. Further, storing the annotations apart from a viewed document permits the document to remain pristine despite numerous annotations (audio or otherwise). Viewed another way, separating annotations from the underlying document permits a user to annotate a previously unmodifiable document. One example is annotating documents stored on CD-ROMs. Another is to annotate a shared document, which the user has no permission to modify. Yet another is to annotate a web page or other media that is traditionally not editable by users.

The separate storage of annotations also facilitates sharing because it means that one needs only make the annotations accessible for others to access; copies of the documents themselves do not need to be transferred if, for example, the various users already have access to their own copies. As an example, should a scholar make annotations to articles in Microsoft Encarta®, then all owners of the Encarta® CD-ROM may gain access to the shared annotations within their present copy of Encarta®.

Another aspect to storing annotations in a separately accessible database is the ability to share annotations between users independent of the underlying document. In a first example, users may access networked annotations of others as easily as accessing their own annotations. This may be controlled through the use of permissions and views that give the users access to desired and permitted information. For example, if Tom wishes to access Fred's comments on document A, Tom opens document A, uses a settings user interface that lets him specify that he wishes to display annotations authored by Fred (including possibly audio by Fred). In response, Fred's comments (audio and otherwise) are manifested in document A the same as those created by Tom himself. Additionally, users may simply exchange locally stored annotations (for example, attaching annotations to an email or transmitting through an IR port). In a further example, users may store annotations on a network and thereby permit others to access the created annotations through known network information exchange pathways including email, file transfer, and permissions (reflecting access to a sole user, a workgroup, or a community). A further aspect of sharing annotations is the ability to create new annotations that annotate existing annotations (which may in turn be annotations on other annotations or documents). Annotating annotations is similar to discussion threads as are known in the art, in which a history of comments and exchanges may be viewed. As are known with discussion threads, one may collapse or expand (for example, through a settings user interface) the type and depth of annotations that are played or shown to the user.

The ability to associate a document with multiple sets of annotations supports a variety of businesses. A publisher in this example could as easily sell two versions of the book, one that contains the annotations and one that does not. This provides the opportunity for the textbook alone to fetch a first price on the market and a second, higher price when audio annotations from a well-known lecturer are added to the electronic information.

The above and other benefits of the invention will be apparent to those of skill in the art when the invention is considered in view of the following brief description of the drawings and detailed description.

### BRIEF DESCRIPTION OF THE DRAWINGS

FIGS. 1A and 1B are block diagrams of a computer system that may be used to implement the present invention.

FIG. 2 is a schematic representation of insertion of a set of audio clips at the beginning of one page and extending through another page of a first book, and further including pages of another book in accordance with one embodiment of the present invention.

FIG. 3 is a representation of a screen of having a simplified audio annotation interface according to embodiments of the invention.

FIG. 4 is a representation of a screen of having an advanced audio annotation interface according to embodiments of the invention.

FIG. 5 is a flow chart showing a process for associating recorded audio clips with properties according to embodiments of the invention.

FIG. 6 is a representation of a screen indicating the presence of an audio annotation according to embodiments of the invention.

FIG. 7 is a representation of a screen showing multiple audio annotations according to embodiments of the invention.

FIG. 8 is a flowchart showing a process for playing back audio annotations according to embodiments of the invention.

FIG. 9 is a flowchart showing a process for playing audio notes matching a property according to embodiments of the invention.

FIG. 10 is a flowchart showing a process for playing audio annotations and associated pages according to embodiments of the invention.

FIG. 11 is a functional diagram of an audio note recorder and playback device according to embodiments of the invention.

FIGS. 12A and 12B show an annotation being repositioned with respect to re-flowed pages and an associated audio clip in accordance with embodiments of the present invention.

FIG. 13 shows a process for creating an annotation in accordance with embodiments of the invention.

FIG. 14 shows a process for playing back an annotation in accordance with embodiments of the invention.

### DETAILED DESCRIPTION OF THE INVENTION

The present invention relates to capturing and playing audio annotations in conjunction with the viewing of an electronic document. Users may record audio annotations in a variety of circumstances including while reading a book, while viewing a written annotation associated with a book and the like. Further, by permitting a user to annotate the displayed book or other electronic information with a verbal commentary, the user's interaction with the displayed book can elevate from a passive reading activity to an interactive, active reading experience.

For purposes herein, electronically displayed information is considered expansive in scope as including, without limitation, text, video, audio, graphics, and the like. For simplicity of explanation, the term “document” or “text document” is used herein. However, it is readily appreciated that the invention also may be applied to the other electronically displayed information as set forth above. Further, the term “electronic reading” is also considered expansive in scope as including, without limitation, the display of textual material on a computer display device and the display for a user of still or video images for watching by a user.

Electronic Display Device

The electronic display device according to the present invention may be an electronic reading device such as, for example, a personal digital assistant, a notebook computer, a general computer, a “digital” book, and the like. Where the electronic display device displays video, the electronic display device may be a television set, a computer, a personal digital assistant or the like. Any type of electronic device that allows electronic information to be read by a user may be used in accordance with the present invention.

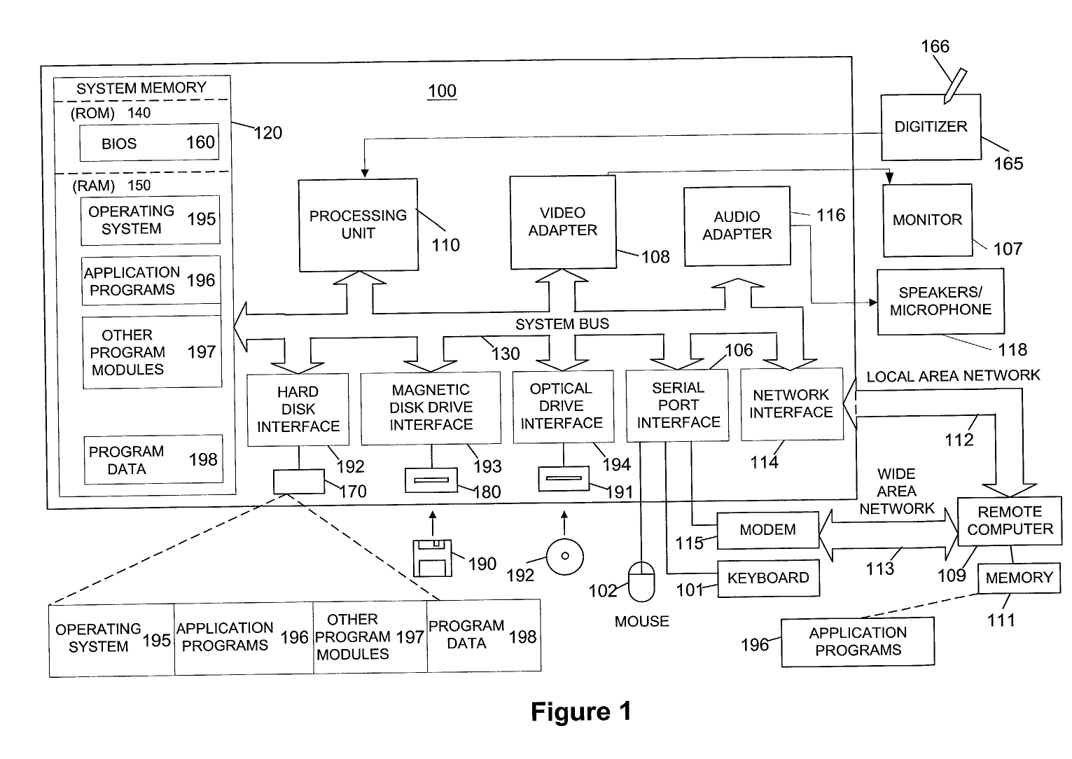

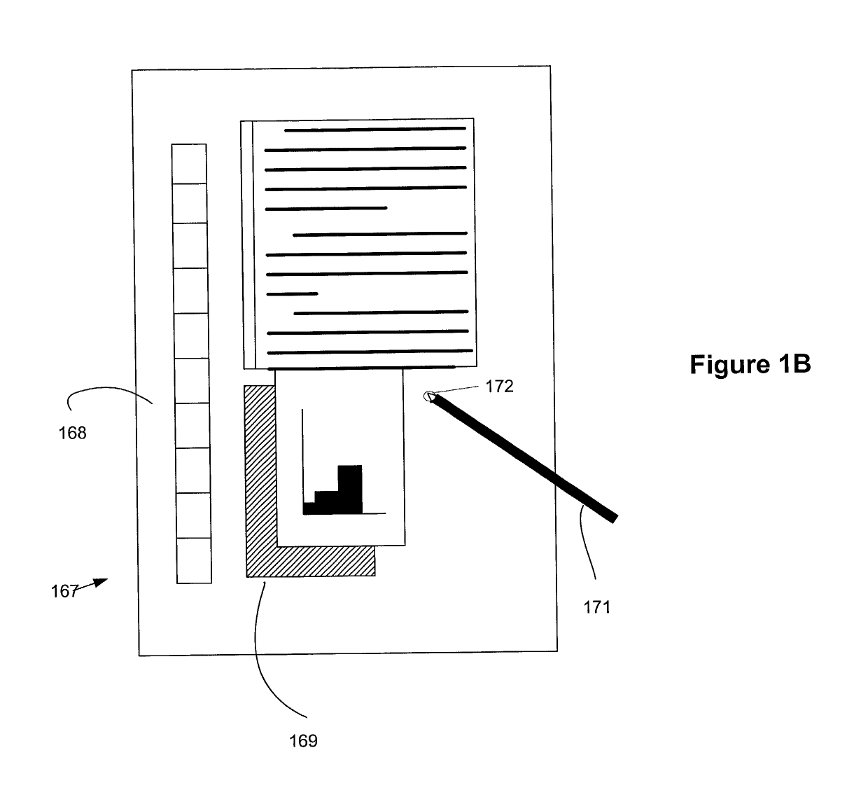

The present invention may be more readily described with reference to the Figures. FIG. 1A illustrates a schematic diagram of a conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. Audio adapter 116 connects to speakers/microphone 118. Personal computers typically include other peripheral output devices (not shown), such as a printer. In a preferred embodiment, a pen digitizer 165 and accompanying pen or stylus 166 are provided in order to digitally capture freehand input. Although a direct connection between the pen digitizer 165 and the processing unit 110 is shown, in practice, the pen digitizer 165 may be coupled to the processing unit 110 via a serial port, parallel port or other interface and the system bus 130 as known in the art. Furthermore, although the digitizer 165 is shown apart from the monitor 107, it is preferred that the usable input area of the digitizer 165 be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1A. The logical connections depicted in FIG. 1A include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are exemplary and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

FIG. 1B illustrates a tablet PC 167 that can be used in accordance with various aspects of the present invention. Any or all of the features, subsystems, and functions in the system of FIG. 1B can be included in the computer of FIG. 1B. Tablet PC 167 includes a large display surface 168, e.g., a digitizing flat panel display, preferably, a liquid crystal display (LCD) screen, on which a plurality of windows 169 is displayed. Using stylus 171, a user can select, highlight, and write on the digitizing display area. Examples of suitable digitizing display panels include electromagnetic pen digitizers, such as the Mutoh or Wacom pen digitizers. Other types of pen digitizers, e.g., optical digitizers, may also be used. Tablet PC 167 interprets marks made using stylus 171 in order to manipulate data, enter text, and execute conventional computer application tasks such as spreadsheets, word processing programs, and the like.

A stylus could be equipped with buttons or other features to augment its selection capabilities. In one embodiment, a stylus could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be used for selecting or indicating portions of the displayed image on a touch-sensitive or proximity-sensitive display. Consequently, the term “user input device”, as used herein, is intended to have a broad definition and encompasses many variations on well-known input devices.

Region 172 shows a feed back region or contact region permitting the user to determine where the stylus as contacted the digitizer. In another embodiment, the region 172 provides visual feedback when the hold status of the present invention has been reached.

Audio Annotations and Audio Clips

Audio annotations are combinations of one or more audio clips. As a user speaks, the system recording the user's voice stores received information as audio clips. The audio clips are separated from each other based a variety of events including: 1) momentary pauses in the user's speech, 2) user actions on the device, such as navigating between pages or documents, and 3) timeouts that set the maximum duration of a clip if neither 1 nor 2 occurs first. The user may be unaware of the fact that annotations are stored as sets of clips. On playback, the system assembles the clips into audio annotations. By the system forming annotations from stored audio clips, the system is able to make finer resolutions between spoken comments (for example when a user continues to speak across numerous pages). These finer resolutions are helpful in interpolating when annotations are to be separated for various purposes including purposes of editing (insert/delete) or playback indexing. By means of example, the system may record a user's voice as a first file, then parses the file to extract the audio clips. As is appreciated by one of ordinary skill in the art that the parsing may occur in real time, may be performed while no speech is occurring (during processor down time), or may be uploaded for processing at a later time.

Users naturally pause in between making what they perceive as discrete remarks, so in essentially all cases the boundary between a user's perceived annotations will also cause a boundary between clips to be created. However a user may also utter a series of related remarks, or a single very long remark, that the user considers to be a single annotation. In such a case, the annotation will be composed of many clips, although this in no way affects how the user perceives the annotation. The user is free to think of each embedded note on a page as a discrete annotation (even though it is composed of many clips) and also may think of the remarks they utter while reading pages as either one long annotation or alternatively as a set of separate annotations they recorded in sequence. The fact that the actual audio stream is divided into smaller clips is transparent to the user and doesn't affect the user's own concept of how the audio stream is organized.

Users create annotations in two ways: 1) by engaging the record function while reading pages of a book (thus associating annotations with the pages as they flip through them and speak), and 2) by inserting (or interacting with) an embedded note and, with recording engaged, speaking while the note still has the focus (thus associating the audio with the embedded note). At a software level, the system may use the state information or current user's focus to determine the name to be associated with the recorded audio clips. With respect to the two ways of creating annotations described above, the name associated with the audio clips will be the user's main document or the embedded note, respectively.

In both situations described above, while recording is engaged, the received audio stream is buffered in memory and dynamically sliced into clips as described above. To permit indexing and other related functions, properties are applied to the clips. This may occur when they are created and again when they're stored. Alternatively, the properties may only be associated with the clips when created or when stored. These properties allow the clips to be reassembled into a continuous stream later, as well as to be retrieved in related groups (e.g., all clips recorded for document A page 3, or all clips recorded yesterday, or all clips recorded yesterday by John).

Properties of Audio Clips

Properties are associated with audio clips when created and/or when stored as described above. Properties help a user retrieve audio clips as audio annotations. The audio clips may be stored in a database to facilitate dynamically accessing the audio clips based on user-defined queries. This ability to retrieve the audio information based on user input is a separation from the linear nature of recording most users' expect. Here, the storage of the audio information includes properties that permit the audio information to be associated with the visual so that one may be displayed in synchronism with the other.

Compared to the rigid mechanism of a linear audio tape or file, the retrieval based on user queries provides great flexibility on how users record and listen to audio notes, and in particular it lets users take advantage of the visual display as a way to organize and retrieve audio notes. Through the addition of audio information, the electronic information is enhanced by making it more memorable, more informational, and more interesting than non-audio enhanced electronic information.

Properties may include, but are not limited to, position data indicating the location in the electronic information at which the user inserted the audio annotation, time data indicating the time of creation of the audio note, user data indicating the identity of the user that created the audio clip, and the duration of the clip.

In addition to the properties provided above, the present invention, in one embodiment, includes a navigation history feature that records all document navigations indexed by time, so that, knowing the position and time of a given audio clip, the system may determine the preceding and succeeding clips in document or time order. Navigation history provides at least the following two advantages. First, because all navigations have been indexed by time, the system may play back, not only the audio that was recorded during a session, but also the sequence of document navigations. For example, a user may attend a lecture during which the lecturer showed presentation slides. When reviewing the presentation after the fact, the user may cause the recording of the presentation to play back with the slides switching in the same order as during the original live presentation and with the audio playing back at the same time.

Second, because all annotations, including voice and text annotations, are timestamped with their creation time, the system may cross correlate the two types of annotations during playback. For example, as described later in the section on one touch playback, the ability to cross correlate based on time means that when one taps on a handwritten note, the audio playback may be automatically indexed so as to play back what was being recorded at the time when the handwritten note was being entered. Likewise, using time as a cross correlator permits a mode to be implemented where a selection highlight automatically tracks through the notes while audio is being played back, so as to show a user what was being written at each point in time.

Audio Annotations and Pages

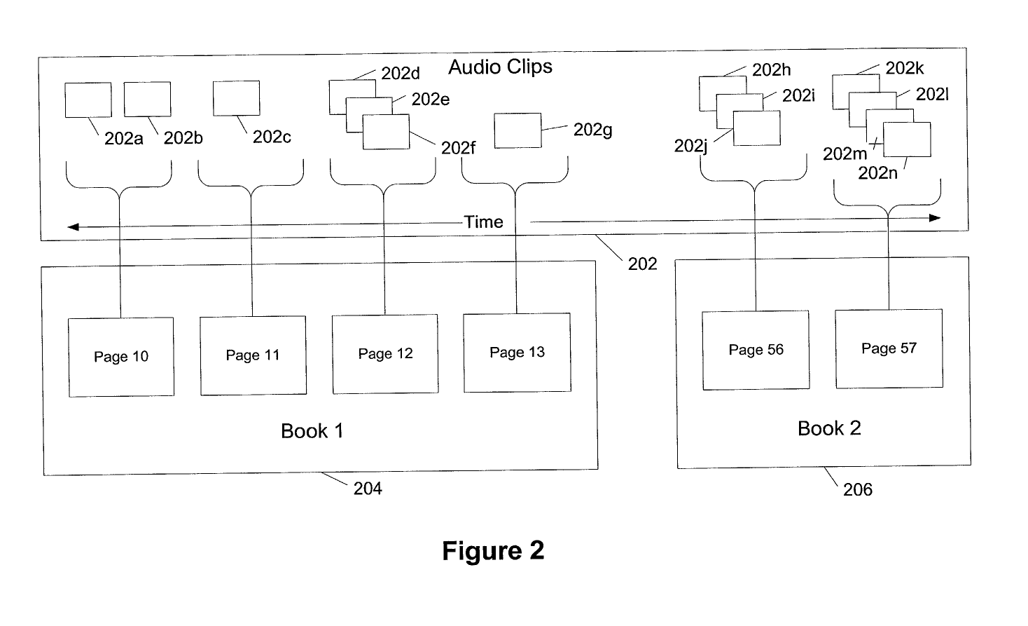

FIG. 2 is schematic representation of a set of audio clips 202. The set of audio clips 202 is typically formed of multiple individual audio clips that have been separately recorded. Any number of audio clips may be associated with any page of textual information. In addition, the audio clips may be recorded at a variety of different times. The electronic information (shown here as pages) in FIG. 2 are provided as pages in an electronic book. Once inserted, the audio clips add richness to textual electronic information. On playback, the set of audio clips may be combined into a single audio stream and is derived by query from a database. It is appreciated that any type of electronic information, for example video, may be displayed on any device supporting electronic reading. In the example of annotating video information, adding audio annotations to a video presentation permits a user to comment on displayed video information.

Storing the audio clips in a database is but one embodiment of the storage aspect of the invention. At least one advantage of storing the audio clips in a database is the ability to randomly access the audio clips and to add properties to the audio clips. Other ways of storing the audio clips include storing the audio clips (or at least links to the audio clips) as a linked list, as a table, and in any form that permits access to the clips.

In the present example, individual audio clips 202a through 202n comprise audio clip set 202. As shown in the example of FIG. 2, the audio clips may be stored as individual audio notes or portions that may be arranged into audio annotations based on user preference. For example, FIG. 2 shows individual audio clips being associated with pages of a first book 204 and pages of a second book 206. More specifically, two individual audio clips 202a and 202b are associated with page 10 of the first book 204; one clip 202c is associated with page 11 of first book 204, etc. Other individual audio clips are associated with second book 206. In the example, page 56 of book 206 has associated audio clips 202h, 202i and 202j. In one embodiment, the process of selecting individual audio clips 202a through 202n to the set of audio clips 202 is transparent to the user. For example, a user may request all audio clips associated with Book 1 be sorted in page order. The resulting audio stream would include audio clips 202a-202g. In another embodiment, the user may request all audio annotations for Books 1 and 2 in order of recording time recorded before a given date. The resulting audio stream may include, for example, the following clips in order: from Book 1, 202a, 202d, 202b, 202c, 202e, then flipping to Book 2, clips 202h, 202k, 202i, 202l, then back to Book 1 for clips 202g and 202f. Here, clips 202j, 202m, and 202n may have been recorded after the given date. In a third example, a user may request all audio clips be arranged in relation to the author or content of the comment including “all audio clips by Mr. Jones” or “all audio clips relating to astronomy”. In regards to the content, the system may include a property in the audio clips that defines the content. This may be accomplished as well as by the title of the audio clip or by the title of the viewed document as stored with the audio clip when the audio clip was made. In short, the order of the audio clips in the audio stream is dependent on how a user queries a database (where the database storage structure is used). Further, predefined queries may also exist that permit a user with canned playback orders, thus minimizing the number of separate inputs a user has to make to start playback. Examples of the canned queries include “all annotations of currently viewed document, ascending in creation time order”, “all annotations of all documents, descending in creation time order”, etc. Other combinations and permutations for stored queries are possible and considered within the scope of the invention.

Referring to FIG. 2, in at least one embodiment, a separate file storing the audio annotations is created with pointers back to their associated page. In some embodiments, the pointers may also include location information designating the location on the page where to display an icon indicating the audio annotation exists. In an alternate embodiment, the audio annotation may be inserted into the file structure of a document itself, thereby expanding the amount of information conveyed in the single document.

Audio Tapes

As described above, a user may request playback of audio annotations through the submission of queries. To simplify this process, the system includes predefined queries. In one embodiment, these predefined queries are referred to as “tapes”. The ability to select tapes exploits a user's familiarity with cassette recordings and audiotapes, while managing to provide additional functionality of user definable queries as well. The system provides default tapes. For example, a system belonging to John may select a tape named “John's Master Tape” from a selection of other tapes. Selecting “John's Master Tape” submits a query to the database of audio clips to retrieve all audio clips authored by John across all documents in time order. Other tapes may be defined for each document and the like. This selection of tapes provides a user with the functionality of being able to retrieve predefined sets of information with the ability to customize queries as well.

A user may concurrently access a number of tapes while reading a document. For instance, a user may have a first tape for notes on the content of a book, have a second tape for notes of additional books the user would wish to read, have a third tape for adding editorial comments for another user, have a fifth tape for recording audio annotations taken in conjunction with a presentation, and have a third tape (unrelated to the first two) for recording of notes of items to pick up at the grocery store after getting home. In this regard, selecting a tape then recording generates audio clips with properties including the user's current focus, including, at least in part, the name or other identifier of the selected tape.

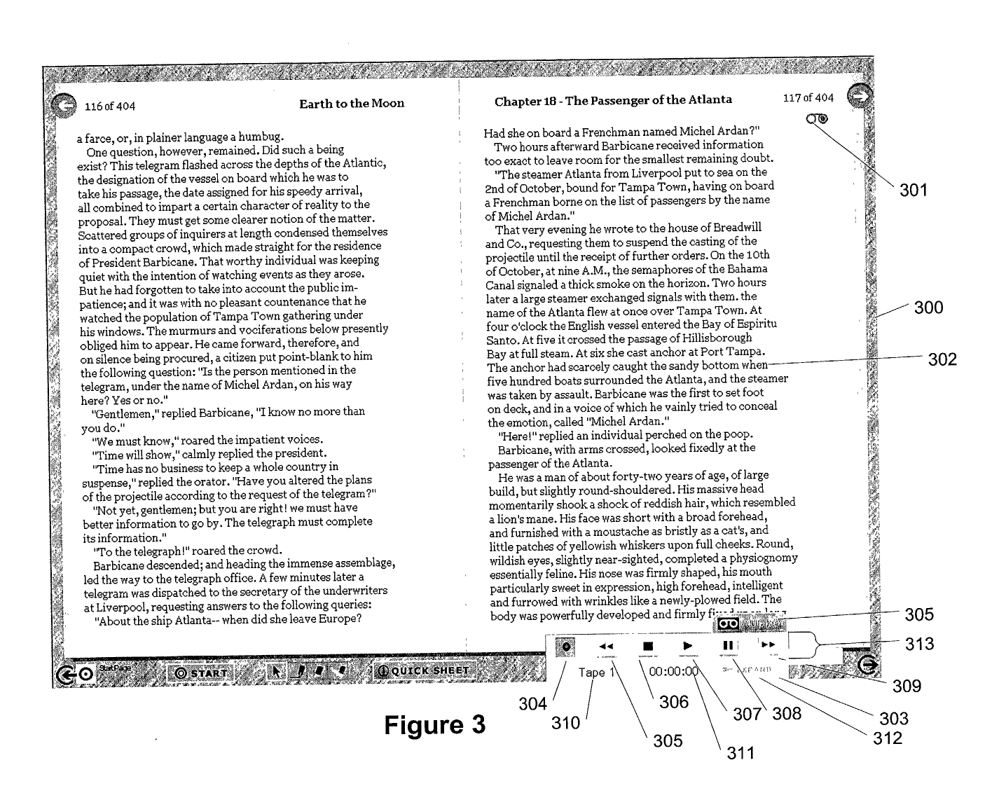

As applied to FIG. 3, display portion 310 indicates the identity of the tape currently receiving/playing back audio annotations. It is appreciated that the identity of the tape is definable by the user. The ability to name tapes makes for later identification easier. The names may relate to previous queries. For example, a user may have a tape named “History Class Notes” where the database query was “all annotations where subject is ‘history class”’. In another embodiment, the system also provides intelligent naming of audio clips to match that of the tape currently being recorded or played back. For example, when playing back a tape “History Class Notes”, a user may create a new audio annotation to comment on a previous audio note. Here, the system determines the name of the current tape “History Class Notes” and assigns properties to the new audio clip to make it part of the History Class Notes tape. In the example of the audio notes being stored in a database, the new audio clip would have the property “subject=history class” so as to be part of the History Class Notes tape (or, more precisely, the virtual tape or audio stream) as described above. The property may be represented in a number of forms including XML and other mark up languages or by a predefined coding system and the like.

The tape may be selected by the user by for example, a drop down interface or any other known selection mechanism. While the user may operate a user interface to load or unload a tape, the system views the tapes as virtual in that the tapes are predefined queries. In this regard, loading a tape is equivalent to setting values for one or more properties that are used to A) query the database for existing clips that match the property or properties so they can be retrieved and made available for playback or editing, and B) associate that property or properties with any newly recorded clips. Further, associating audio with a given tape does not interfere with playing the same audio back according to other desired views. For example, even though a set of remarks was recorded under the “History Class Notes” tape, those same remarks would nevertheless be accessible when, for example, playing back annotations “recorded by me yesterday morning”, assuming some history class notes remarks were recorded yesterday morning. Also, the use of the “tapes” metaphor is simply one embodiment of a user interface. It is equally feasible to present just a database query UI where the user fills in any desired combination of property values, and where the user has the ability to create named views for reuse later.

Audio Controls and Display

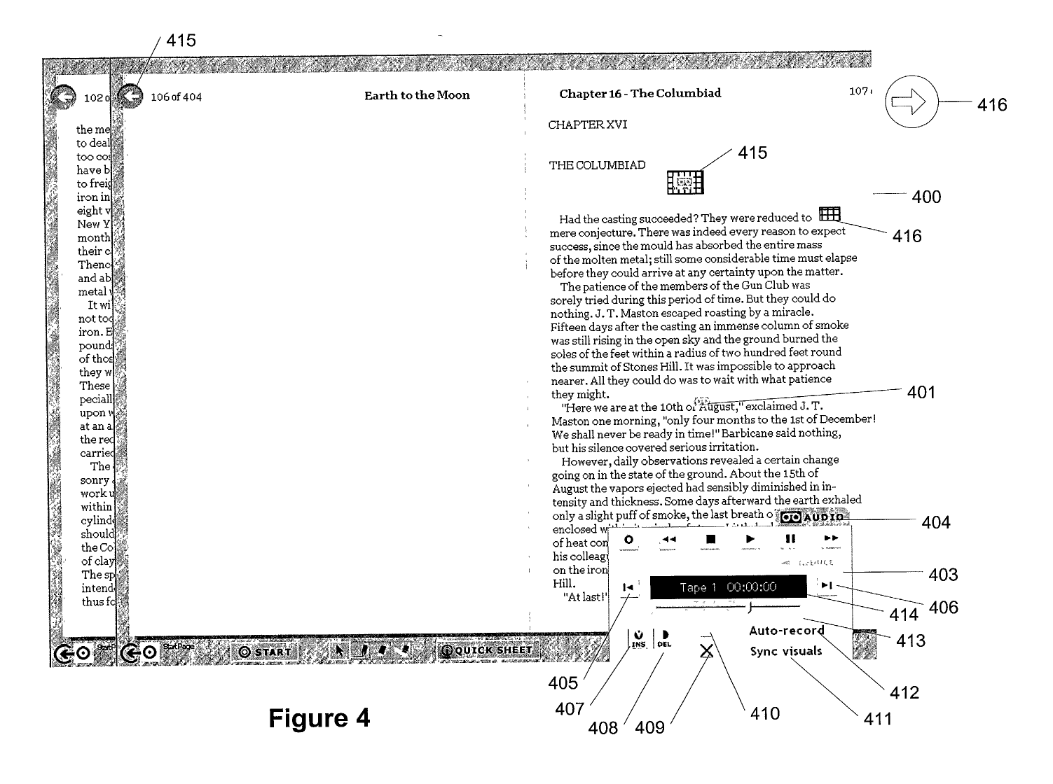

FIG. 3 is a representation of a screen of an electronic display device 300 displaying two pages (pages 116 and 117 of 404 total pages), text 302, a page recording indicator icon 301 and recorder controls icons 303 (also known as buttons). Icons 303 include record button 304, index back button 305, stop button 306, play button 307, pause button 308 and index forward button 309. In one embodiment, the present invention provides a feature that may be implemented by simply clicking on, touching, tapping, tapping and holding, resting the cursor over or otherwise activating functions related to icon 304-309. Tab 305 indicates the title of the display shown in display portion 303. In some instances, tapping has a different effect than holding down a control button. For example, tapping the index back button 305 seeks to the previous clip in the tape. Tapping the index forward button 309 seeks to the next clip in the tape. Holding the index back button 305 seeks to the start of the first clip associated with the current page being viewed. (See also the automatic seek function described below.) Holding the index forward button 309 seeks to the end of the last clip for the current page. This is mainly useful with the advanced control set (FIG. 4), where recording can be made to insert rather than overwrite additional comments to a page.

FIG. 3 shows the screen 300 having a simplified audio annotation interface 303. To further simplify the interface, only a subset of the control buttons 304-309 may be displayed as subset 313. Display portion 311 relates to elapsed recording time. Display portion 312 provides a user with an option to expand the content of display 303. The expanded display is described in greater detail with respect to FIG. 4.

When the user initiates the audio annotation feature, the electronic device may record the current position in the text as one of the properties of the audio clip. Then, as the user navigates the electronic information by turning pages (activating the arrow icon at the top left or right of the pages shown in FIG. 3 for example), following links or the like, the navigation information is stored to preserve both the time in history and the relationship to the current location for each audio clip. The audio clips and related navigation and location data may be stored outside of the actual content being viewed, that is, they are stored as objects that are linked to the content. This implementation provides for very rich interaction with the resultant data. Storing audio clips externally allows the underlying electronic information to be documents that a user has no ability to write into or modify, such as a CDROM-based book, or a web page, or a file for which users do not have write permissions. Storing audio clips separate from the underlying electronic information also facilitates the sharing of audio annotations among collaborators, because the annotations can be overlaid on each collaborator's copy of the document, even if all their copies are distinct.

An additional embodiment includes a graphical embellishment that indicates when the tape is positioned just before the first piece of material recorded with respect to the current page, or just after the last piece of material for that page. Here, the tape indicator may flash when playback or recording is in progress.

FIG. 4 shows an expanded interface 403 relating to an audio annotation associated with page 400. Icon 401 indicates a specific location referenced by an annotation. Buttons common to FIG. 3 are treated above with respect to FIG. 3. FIG. 4 includes rewind to beginning button 405, fast forward to end button 406, a slider 413 that indicates relatively how far along a current annotation is among a tape. Display portion 414 indicates the tape name and the elapsed time. Tab 404 indicates the title of interface 403. Buttons 407 and 408 allow the insertion of a new audio annotation at a selected point and deletion of a specified portion of the annotation, respectively. With respect to the deletion of a portion of the audio annotation, upon selection of button 408, the system may play a portion of the annotation in a different way so as to indicate that the played portion is being deleted or will be deleted. The different way may include the use of background tones, higher or lower pitch settings, higher or lower speeds, and the like, optionally accompanied by an indication on the display that an audio deletion is occurring. Check box 409 relates to a selection of synchronizing visual display 411 with the audio clip. The synchronization of visual display with the audio clip relates to an automatic seek function where the audio clips are played to coincide with a user's navigation of a document.

Tape Functions

Once the system has begun recording (auto-recording or manual recording), the system sets a position property value to the currently displayed page. The position property may be an exact position on a page or a general position on the page (the top of the page, the bottom of the page, middle of the page, or located between paragraphs if two paragraphs are displayed on a page). In short, the position property may indicate any coordinate within a document. If a specific word, icon, graphic, or portion of the page (collectively, the selected item) was selected for being associated with an audio annotation, the position property of the audio clip would be the position of the selected item.

The position properties associated with audio clips may be searched and the results combined as the results of the query. “Tapes” are predefined queries that, when selected, retrieve audio clips satisfying the queries. For example, activating a “tape” 310 user interface permits a user to select between various predefined queries such as Master Tape, Document tape, and any other predefined set of queries. A document tape is query that returns all clips in time order for the currently viewed document. A master tape is a query that returns all clips across all documents in time order. A user may find the document tape useful when he only wants to retrieve annotations taken within a given document, whereas the master tape may be useful when he is trying to review all annotations made during a given time period.

Where desired, play and fast forward or rewind may be engaged simultaneously. This simulates the operation of a physical tape. Here, the system may use a compression algorithm to play back an excerpted version of the audio version of the audio stream as the tape winds. Alternatively, the audio annotation may be rendered in a high pitch, providing the modulations of the recorded voice, but at a fast rate. Thus, audio cues are provided about where the tape is positioned. To repeat what was just listened to or recorded, a button may be pressed for playback. Playback or recording resumes after the repeated interval. All tapes (including master tapes, document tapes, and any other predefined or executed queries) may be scanned, played, or material appended thereto. Recording at the end of the tape appends the new clips to the tape.

Ending Recording and Playback Events

Recording and playback may be initiated by tapping the control buttons described above in FIGS. 3 and 4. In addition to tapping stop button 306, other user-generated events will signal that recording or playback is to stop. In recording mode, activation of the audio controls, a long silence in the automatic recording mode (discussed below), tapping on the screen to create a new note, and navigating away from the current page all may signal the end of recording for an audio clip. In playback mode, activation of the audio controls, an ambient noise level exceeding a threshold (in the automatic recording mode), tapping on the screen to create a new note, and navigating away from the current page all may signal the end of playing back of an audio clip.

User Preferences and Controls

A settings sheet (not shown for simplicity) allows the user to preset various features of the device, such as to inactivate the locking behavior of the fast forward and rewind buttons relating to a user's preferences. Similar settings may include determining the speed of fast forwarding and rewinding.

In one aspect of the present invention, the controls for the system are normally not visible until implemented by a toolbar that is, by default, generally hosted in a command shortcut margin and initially closed. In this implementation, a toolbar tab is found in the shortcut margin, similar to a bookmark tab. Activating the tab opens the interface portion 403 (or 303) into the margin. In one implementation, the toolbar slides out form the margin edge. Activating the tab again retracts it, leaving only the tab. For convenience, where desired, the toolbar may be deleted or moved to a different desired location. Where the toolbar tab has been deleted, it may be recovered by obtaining another copy of the toolbar as is known in the art.

Where desired, the record control 304 (in both FIGS. 3 and 4) may have a light that is on when recording, similar to a mechanical tape recorder. In one example, the light may remain lit. In another, the light flashes during recording. To repeat what was just heard or dictated, a user may press play while already in playback or record mode. Analogous to a CD-player, a user may index back or forward to move the tape position back and forth between audio clips in the recording.

The system of the present invention also may include index forward and index back buttons 405 and 406. In the situation where, each tape includes multiple clips, activating the index buttons 405, 406 cause the system to seek the next clip (or previous clip) in the tape. Holding the index back button 405 causes the system to seek the start of the first clip associated with the current page being viewed (Similarly, the automatic seeking function does this when it is enabled.). Holding the index forward button 406 causes the system to seek the end of the last clip for the current page. Index buttons are used when the play mode is engaged. A user may designate the default operations of the system (whether for record over a previous audio clip, or to insert a new audio clip at a selected location).

FIG. 4 further shows a combination of an audio clip icon and text note icon as grouping 415, indicating a text note with audio associated with it is present. Another text note icon is shown as 416. One may create the combination by creating a note and writing into it, and also speaking while the note is open and recording is engaged. The system decides how to visualize a note based on its contents. If it contains ink/text only it displays as something that looks like, for example, a little sheet of notes or any other icon relating to notes (for example, sheet of paper icon 416). If it contains audio only it displays as a cassette icon 401 (or any other icon suggesting recorded sound). If it contains both visual and audio information it displays as an icon that combines the imagery of a note sheet and cassette icon, for example, as icon 416.

Properties and Association with Audio Clips

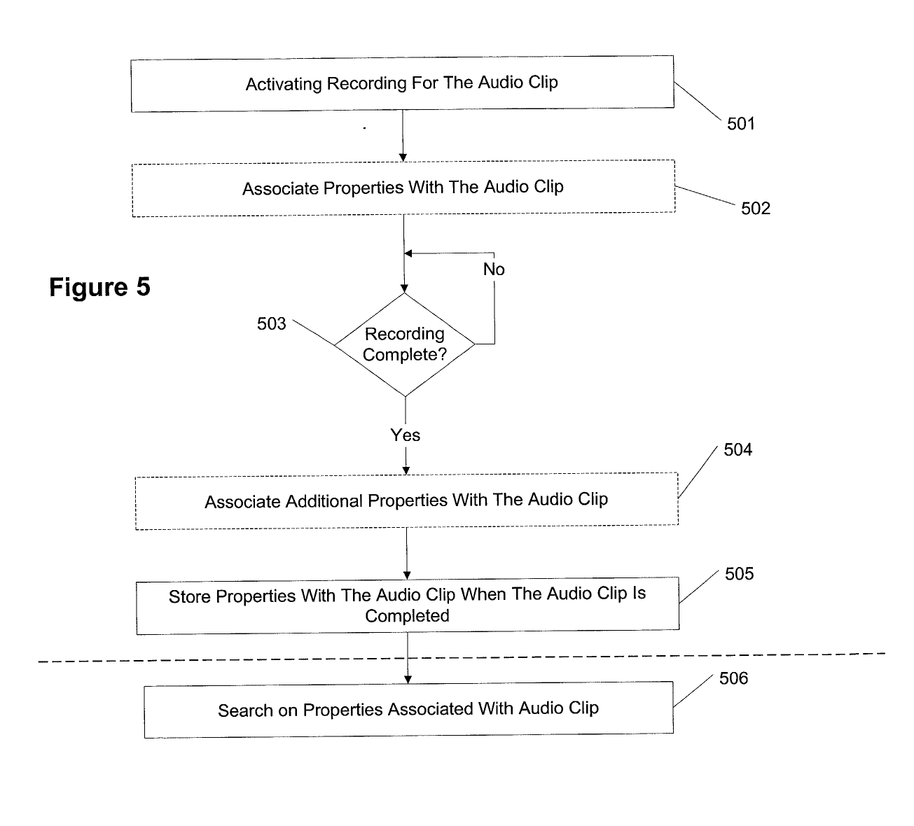

FIG. 5 shows a method for associating a property with an audio clip. First, the recording function of the system is activated as shown in step 501. This may be accomplished by a user activating the recording function through selection of the record button 304. Alternatively, the system may be set on voice-activated recording. In this instance, when an audio signal level reaches a predetermined threshold for a predetermined period, the system begins recording and stops when the signal level drops below the predetermined threshold for the predetermined period. In a more sophisticated implementation of voice-activated recording, the software may take advantage of speaker-dependent voice recognition to start recording only when the audio signal level exceeds a threshold and when the recognizer indicates that the user's voice is recognized. This mode of voice activation is most useful when a user wishes to record only their comments and not have recording triggered by background noise.

Next, in step 502, some properties are determined (for example, starting time, author, start recording date, and the like). In some embodiments, step 502 is optional as some of these properties may be acquired later.

Next, in step 503, the recording continues until completed. This includes turning off the record function by toggling button 304 or pressing stop button 306. Alternatively, this may include the voice-activating recording having not been actuated for a predetermined interval (for example, five seconds). When completed, additional properties to those determined in step 502 (or all properties if no step 502) are determined and associated with the audio clip as shown in step 504. Additional properties include the length of audio clip, the time the recording ended, the date the recording ended, the identity of the user who controls the system (in an electronic book example, the owner of the book), the identity of the person who's voice is on the audio clip (for example, the name of the lecturer giving a presentation), the title of the electronic information, the page or other location identifying information specifying the location of the audio clip in the electronic information, and the like. Further, the properties associated with the audio clip may include any other information. To this extent, a user may set properties to be associated with newly recorded audio clips. These properties remain in effect until the user changes them or some other event (for example, a navigation event) occurs.

Next, the properties are stored with the audio clip as shown in step 505. Other storage techniques are possible and are considered within the scope of the invention including storing the audio clips in portions or incrementally as they are recorded. At this point, the audio clip is ready for searching by a user as shown in step 506. Here, the user specifies property criteria to find (for example, all recordings made on Jan. 1, 2000 or all recordings made in Chicago).

The form of the stored properties may vary. In a first example, a traditional database is used to store the audio clips. In this embodiment, the database has a table structure that has a table column for each desired property, plus an additional column for storing the audio bits that are part of the clip. In another embodiment, the properties may be simple text where the system knows what the text signifies by its position in the audio clip. In a third example, the system uses a mark-up language (for example, XML) to define the properties. Using XML, various devices may then work with the properties without requiring access to the structure of the second example. XML format may still be used when transferring audio clips between devices as the formats used for transfer and storage can be and usually are different as are known in the art.

Annotations of Annotations and Annotation Links

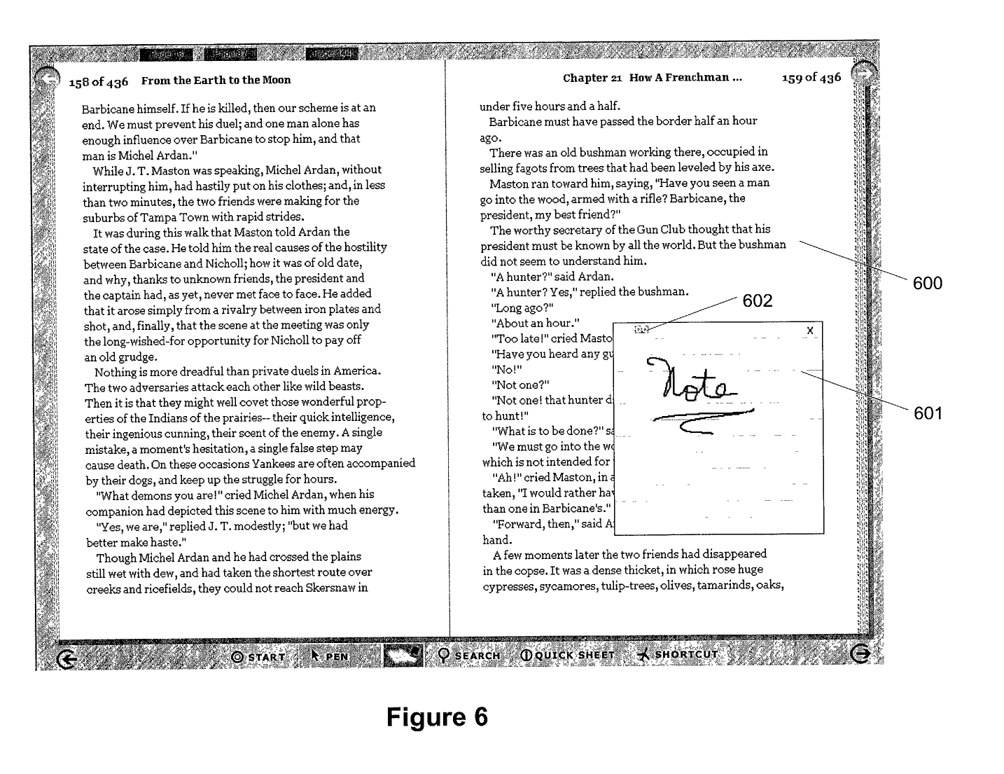

FIG. 6 shows an example of a user note that may contain an audio annotation as reflected by icon 415 of FIG. 4. In addition to being able to associate audio clips with pages or items in a viewed document, the system permits audio information to be associated with text notes or other displayed item or information. For example, a document author may create a document with a link between a word, a graphic image, or an icon and an audio annotation. So, by tapping the item (word, graphic image or icon), the link is activated and the system plays the related audio annotation. FIG. 6 shows a text note 601 on page 600 with an audio annotation 602 associated with the text note 601. The audio annotation represented by icon 602 may start to play automatically after a user accesses note 601 or may wait for a user to tap on it prior to playing.

The recorded audio annotation may be inserted into the viewed document. However, it modifies the underlying document. An alternative process for creating user-defined links is for the user to determine a location (or object) for the link and record the annotation. The location may include the document position of the item to support the link. The system then stores the document position of the item as a property of the annotation. When the item is later selected by a user (for example, by tapping the item), the system checks the properties of audio annotations to see if a document position matches the tapped on item. If so, the system plays the audio annotation with the matching property. Links may be added, deleted or disabled, as is known in the art. Source anchors may be used to set a character, word, paragraph, image, part of an image, table row, cell, column, arbitrary range of document positions or the like (collectively “items”) as an anchor for the audio clip. Similarly, a destination anchor may be selected. Links may be placed anywhere, for example, over a bookmark. An advantage of the above-described process is that it permits addition of links to a viewed document without the modification of the viewed document.

More specifically, links are externalized from documents just as annotations are. That is, when a link between a source and destination is created, a link object is created and stored. The link object has properties that describe both the source and destination anchors of the link. The source anchor specifies the document name and document range where the link is to appear, as well as parameters governing the appearance and behavior of the link in the source document. The destination anchor specifies the document name and position that is the target of the link. For example, a common kind of link may specify that a link exists between document MYDOC and YOURDOC, where the source anchor occupies a range overlapping a word of the document and causing it to display as blue underlined text, and where the destination anchor specifies that the link leads to page 3 of YOURDOC. Thus, tapping on the hotspot defined by the source anchor's range will cause the display to navigate to page 3 of YOURDOC. Links may have other appearances and behaviors, such as buttons, icons, graphical images, and frames that display part of the content that is being linked to. The display mode and behavior of a link is governed by the properties on the link object.

Links, by being external, have all the same advantages articulated earlier for audio clips. Also like audio clips, links are stored in a database, so they have the same query/view flexibility of audio clips. For example, one may display only links created by the user, or by members of one's workgroup, or all links newer than some date, etc. The document renderer uses the current view to query the links database for links defined in the current document whose source anchors overlap the current page. It then fetches the properties of any such retrieved links to determine where and how on the page to render the link hotspots.

Now, in the context of the creating links that play audio when tapped, one embodiment under the present architecture permits links to exist between a document and a set of audio clips. That is, the destination anchor of such a link would reference an ID property that was associated with the audio clips that will play when the link is tapped. This kind of link would have the behavior of playing audio when the link is tapped but would cause no other action (i.e., no document would be navigated to). In an alternative embodiment, there is instead the idea of embedded notes. In this embodiment, the user is able to insert what they perceive as audio notes into a document that appear as note icons which, when tapped, play back audio. The implementation of this is to create a note document along with a link whose source anchor renders as a note icon in the source document, and whose destination points to the start of the note document. A further feature of this implementation is that when the note icon is tapped, the system checks the note to see if it contains only audio. If the note contains audio and no other content, then, rather than opening the note document for viewing, the system just plays its associated audio (if in playback mode) or directs recording into that note (if in record mode). At implementation level, both are accomplished simply by changing the property denoting the current audio focus to point to the note document instead of the main document.

One distinction between the second implementation versus the first one lined is that the second implementation is simpler and has more features. That is, rather than have one mechanism for associating audio clips with ranges of document positions (for page-level audio) and another one for associate audio clips with embedded links, the system uses page-level audio only and take advantage of the another existing feature (embedded notes) to provide the functionality of a link to audio. That is, from the user's point of view, the behavior is the same—tap an icon and audio plays. But the second mechanism is simpler (one mechanism instead of two) and more powerful (because one may always add ink/text to the audio note, or go back to an ink/text note and add audio, and thus have notes that contain both media).

Various tap and hold operations may be used for the link process: navigate, for navigating to the link destination; preview, for previewing navigational information; and run, which causes the destination to be executed.

Searching

The following describes an example of how searching may occur. Tapping on a search button (not shown in the interfaces of FIGS. 3 and 4 for simplicity) opens a search form. To initiate a search while on this form, one dictates search terms as separated speech. One may optionally use search fields to scope the search according to date/time, document, and page ranges.

The system next proceeds to search for the desired keywords using a matching algorithm (binary, fuzzy logic, dynamic spectral comparison and the like) to compare the search terms versus previously stored voice notes. The system may process this request internally if it has stored audio notes that contain separated words, or by shipping the request out to a server if the audio notes are server-based or if the processing can be unloaded from the playback device. The server may employ a much more sophisticated search engine (for example, DragonDictate by LNH) that may be able to find words in continuous speech streams. Further, at any time after audio is recorded, it can be post-processed in the background either on the client or on the server so that the audio contents may be analyzed and any recognized words extracted and analyzed to determine if they represent interesting keywords. Any such keywords can then be added to the clips they appear in as textual properties. The textual properties can now be the basis of a very efficient search that provides the appearance and the effect of later doing a real-time search of the speech stream.

First, an audio clip (or annotation) is recorded (step 701). Next, a user enters a search term in step 702. In the situation where the user verbally entered a search term, the system scans the audio clips for a matching pattern (step 703). Finally, the system displays and/or plays the results (step 705).

Shown in broken lines is optional step 706 where the audio clip is converted to text using known voice recognition technology. The text file is associated with the audio clip/annotation. In step 703, the input verbal search term is converted to text and the text file searched for a match with the results being displayed in step 705. Where the input search term is text from step 702, the system matches the search text against the stored text file in step 704 with the results being displayed in step 705.

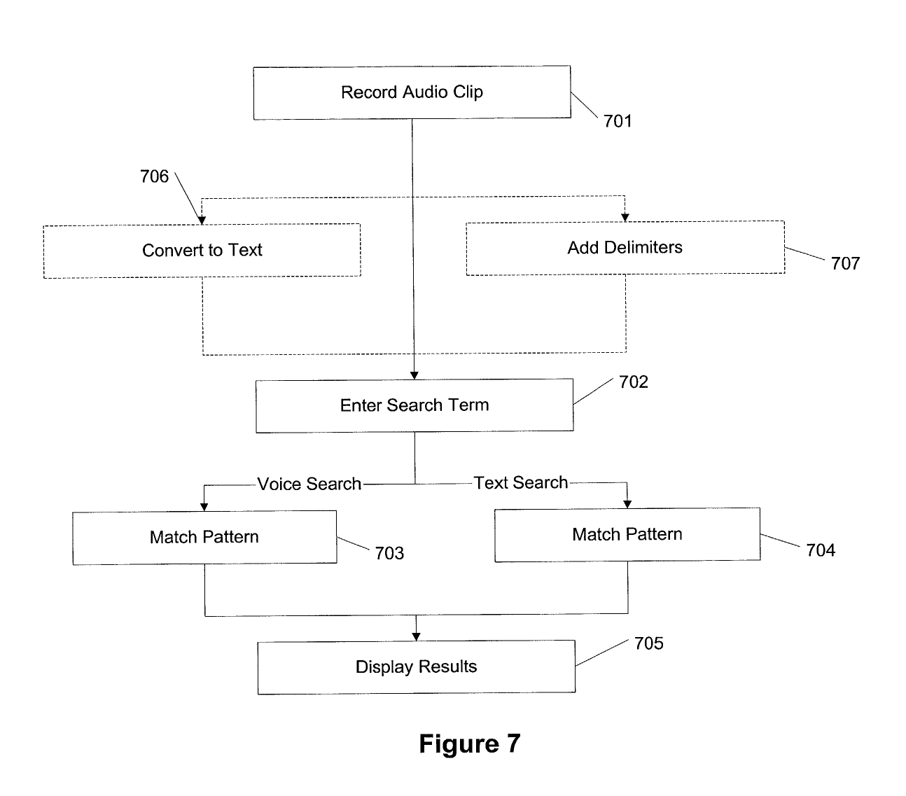

FIG. 7 further shows optional step 707. Step 707 relates to the system adding delimiters to the audio clip or audio annotation when special emphasis is used on a word or words. This function may be supported in at least two ways: when dictations are recorded, certain words may be deliberately enunciated in a separated manner, e.g., be bracketed by short silences or be spoken loudly and the system recognizes these words as search terms and tracks them accordingly. Alternatively, dictations that are uploaded to servers may be processed by continuous speech engines. Other voice recognition systems are known in the art. When delimiters are present in the audio clip or audio annotation, the system may search on only the delimited word or words in step 703 or 704.

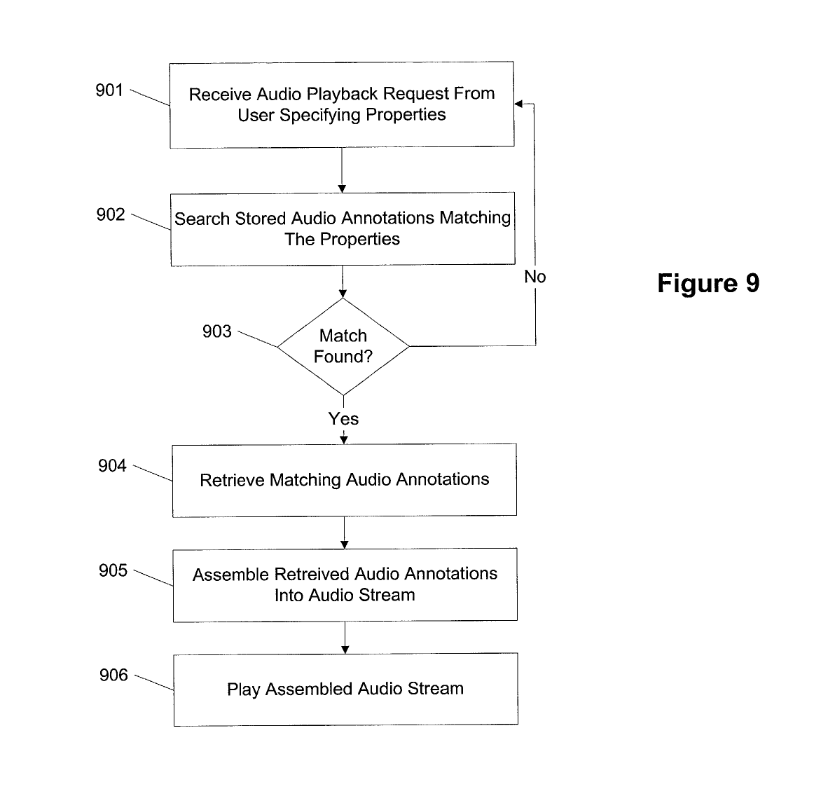

FIG. 9 shows a process for searching properties of annotations and playing the matching audio annotations. In step 901, the system receives an audio playback request from a user, the request indicating a property query. Next, the system searches the stored audio annotations for query matches (step 902). The system determines if a match was found in step 903. If no match was found, the system returns to a waiting state (step 901). If a match was found, the system retrieves the audio annotations (or annotations) matching the query (step 904). Next, the system assembles the retrieved audio annotations into a logical stream (step 905). The audio stream may be a complete file of the matching audio annotations. Alternatively, the audio stream may be a linked list of audio annotations, such that a next one is played upon the completion of a previous one. Finally, in step 906, the audio stream is played for the user upon request or automatically.

Automatic Play (Single Touch Playback)

The system includes the option of automatically playing back annotations. For example, the system may instantly start playing back whatever is on a page as soon as the page is viewed. Also, the system may instantly start playing back what was being recorded when a user shifted focus and started writing a text note, highlighting a passage, or adding a drawing to a viewed document.

Automatic playback (also referred to as single touch playback) enables a mode of reading a document and reviewing recorded notes where a user simply points at notes to hear their associated audio content. In other words, imagine a person as they read along, simply tapping this note and then that note to hear its content. The importance of this feature is that it makes the process of reviewing the audio content of notes very transparent so that it does not interfere with or slow down the process of reading the document. It's also significant that there are different cases of note playback here. One is tapping on an embedded note, in which case that note's content is played back. Another is that of tapping on an overlaid note, such as some handwriting in the margin of the document, or a stretch of highlighted text. What happens in this case is that the audio that is played back is the audio that was recorded in association with that page of the document at the same time as when that note was been entered onto the page. For example, imagine a lecture presentation with slides, and one reviews the slides later with notes one wrote on the slides. By tapping on any of the notes, one is able to hear what the lecturer was saying at the point in time when one was writing the note. As with the embedded note case, auto playback makes it very simple to read through the set of slides and retrieve the relevant audio context associated with each of the notes one scribbled.

Automatic Seek

In addition to the one touch play back system described above, the system also includes an automatic seeking function that automatically synchronizes audio and document positions during playback. If the user navigates to a new page and presses play or is already in play mode, the automatic seeking function starts playback at the first audio clip associated with the new page. For example, in FIG. 4, when the user plays page 107, the automatic seeking function begins audio annotation playback at audio clip 415 (as audio clip 415 is the first audio clip on page 107). Activating the cassette icon adjacent to a page number (for example, icon 301 in FIG. 3) will restart playback with the first audio clip for that page. If the user is viewing a page or navigates to a new page, and presses record or is already in record mode, the automatic seeking function will start recording at the end of the last audio clip for the new page. In other words, when automatic seeking is activated, new comments are inserted after existing comments. If the user navigates the audio clips using the fast forward, rewind buttons (309, 305) or if he just allows the audio clips to play, the automatic seeking function will navigate the document to keep pace with the recording. Further, while viewing a page, if a user taps an existing text note or drawing or highlighting, the automatic seek process will start playback at the first clip that was recorded when that text note, drawing, or highlight was made.

In short, the automatic seeking function eliminates the need to manually navigate the audio clips in most situations. The user may simply turn to any page and start listening to the comments for that page, or add new comments to the page, all without manually positioning the audio clip insertion. Likewise, the user may listen to comments associated with any note or highlight just by activating the associated icon. Alternatively, the user may still choose to manually select the position for the audio clip if he wants to edit or scan the previously recorded comments, as shown by positioning the audio clip record icon 401 of FIG. 4.

The following provides a method of implementing an automatic seeking function. The selection and deselection of check box 409 toggles the automatic seeking function on and off. When the automatic seeking function is engaged, two controlling actions may be detected. First, a user may perform a document navigation event (for example, a user taps a page navigation button 415, 416, a backward or forward history button, or any command or link that navigates a user from one page to another). Upon detection of the document navigation event, the system stops playing a current audio clip (if needed), navigates to the new document or new location within the document, and, using the information of the new document or new position in the document, the system finds audio clips with a matching document position property. Alternatively, the finding step may find audio clips as satisfying a range of positions (top of page to bottom of page, for example). Finally, the system resumes playback starting with the first audio clip satisfying the find step mentioned above.

If the system detects a tape navigation event (for example, a user taps or holds any of buttons 305, 309, 405, 406, or activates slider 413), the system determines the next audio clip to begin playing based on the user's tape control. The next audio clip may be related to a page after or in front of the currently displayed page as the user may navigate forward or backward in the document based on the audio clips. Next, the system retrieves the document position from the next audio clip. Finally, the system displays the document page at the document position indicated by next audio clip's position property.

Automatic Record

In addition to automatic seeking of audio annotations, the system also provides for automatic recording of audio annotations. Check box 410 allows selection of the auto-record feature 412 described herein that automatically controls the recording of audio clips. Through the use of voice activated recording controls, the system records only when a volume threshold has been reached for a predetermined period of time. This recording approach minimizes excess blank portions in the recorded audio annotation. When automatic recording is engaged (for example, through setting a preference on a preferences sheet), the system employs voice activation logic, as described below, to engage recording when sound above a predetermined threshold has been detected for a predetermined interval. The automatic recording mode may be entered by checking the autorecord box 410.

The system also supports single touch recording (similar to single touch playback). With the automatic recording active, a user may only tap the spot where he wants the new recording to be inserted. A note will appear, flashing for example, to attract attention, and will record whatever one says. To finish the recording, one may perform a number of actions including tapping the note to return to the document recording context, tapping somewhere else to create a new note (with an associated switch in the recording system to start recording in conjunction with the new note), and tapping another existing note to switch recording to the existing note. On this last example, the system may further play any existing audio annotations associated with the existing note and overwrite the existing audio note or append any new recordings to the end of the audio annotation.

In short, automatic recording may be summarized as permitting a user to employ a nearly hands-free recording style for creating audio annotations. Users can simply page through a document dictating as they go, or they can simply tap (or click) inside a document and speak to insert annotations at specific insertion points. There is no need to manually turn recording on or off for each separate annotation. Further, with the automatic recording system on, one does not need to manually switch between record and play modes.

If during the recording session, the user desires that silences be recorded as well, the system may monitor the length of the silences and insert an indicator describing the length of the silence. In this situation, a user may play audio annotations at the same rate they were recorded.

The automatic recording feature may work using a combination of loudness, spectral, and possibly rhythmic characteristics to distinguish a nearby voice from background noises, silence, or more distant voices. In an advanced implementation, the system may use speaker-dependent recognition to truly cue itself only on a known speaker's voice.

In one example, it may be beneficial to disable the automatic recording mode. In a meeting, one would want to capture all ambient sounds, not just one's own voice. A particularly handy thing about making a meeting recording is that one can later go back and review it in concert with one's written notes. With the automatic seek function on, one only needs to visit a page of the meeting presentation to hear what was being said at that time, or tap any of one's notes to hear what was being said when one wrote it.

Editing

The system provides for editing of audio clips. If one records over part of an existing clip, that existing clip is truncated and the new recording is a new clip. If one records over the entirety of an existing clip, that clip is deleted. This function may be transparent to the user.

The advanced recorder controls include an edit button that affects the behavior of the record button. Pressing edit cycles the label on the record button among record, insert, and delete. Depending on what the label reads, engaging the button will cause newly captured sound to be overwritten or inserted at the current logical tape position, or it will cause stuff to be deleted from the current position. So that one will know what he is deleting, engaging delete may play back material as it is being deleted; a confirmation step may also as a verification before material is finally deleted. Further the system supports mixing in a noticeable background tone or sound effect as a cue that what one is currently hearing is being deleted. One may use the index buttons while deleting to automatically delete forward and back in sound-clip increments, as well as to the beginning or end of the current page's comments.

Playing Annotations and Displaying Pages

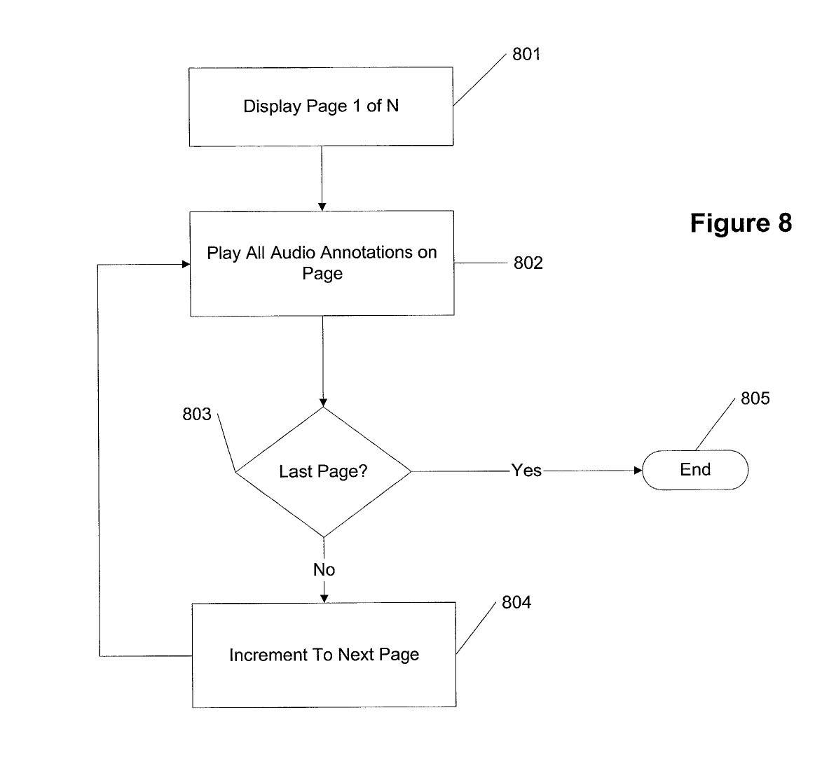

FIG. 8 shows a process for displaying pages and supplementing the pages with audio annotations where present. In step 801, page 1 of a document having N pages is displayed. In step 802, all audio annotations on the page (or associated with the page) are played. In step 803, the system checks to see if the current page is the last page (page N) of the document. If the current page is the last page, the system ends the playback of the audio annotations (step 805). Otherwise, the system increments to the next page (step 804) and plays all annotations present on (or associated with) the page (step 802).

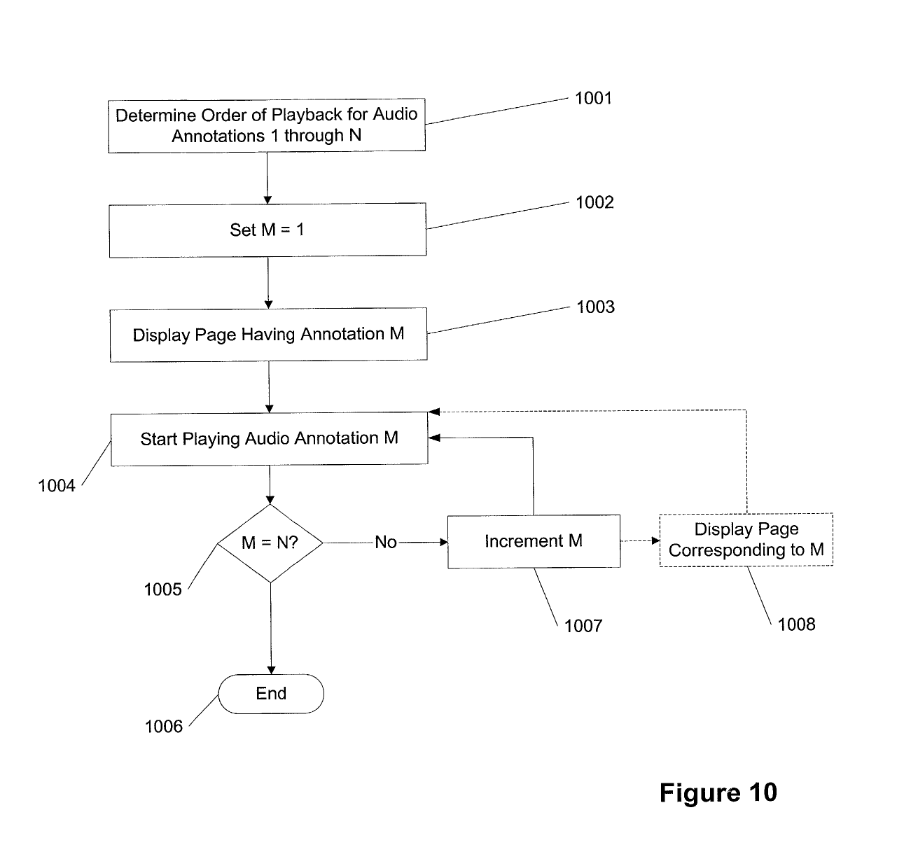

FIG. 10 shows a process for playing audio annotations and supplementing the audio annotations with displayed pages. It is noted that the process of FIG. 8 concentrates on displaying the pages, while the process of FIG. 10 concentrates on playing the audio annotations. In step 1001, the system determines the order of playback for the audio annotations 1 through N (of N audio annotations). For example, the order may relate to recording time, recording location, person recorded, and the like. In step 1002, an audio annotation counter M is set to 1 to signify the first audio annotation in the order specified in step 1001. In step 1003, the system displays the page having audio annotation M. In step 1004, the system starts playing audio annotation M. The system then determines (step 1005) whether audio annotation M is the last audio annotation. If so, the system ends playing the audio annotations (step 1006). If there are more audio annotations, the system increments to the next audio annotation (step 1007) then returns to play the new audio annotation M (step 1004). Optional step 1008 is shown in broken lines. Optional step 1008 displays the page to comport with the new audio annotation M. In this optional step 1008, only those pages having audio annotations are displayed.

Functional Recorder/Playback Device

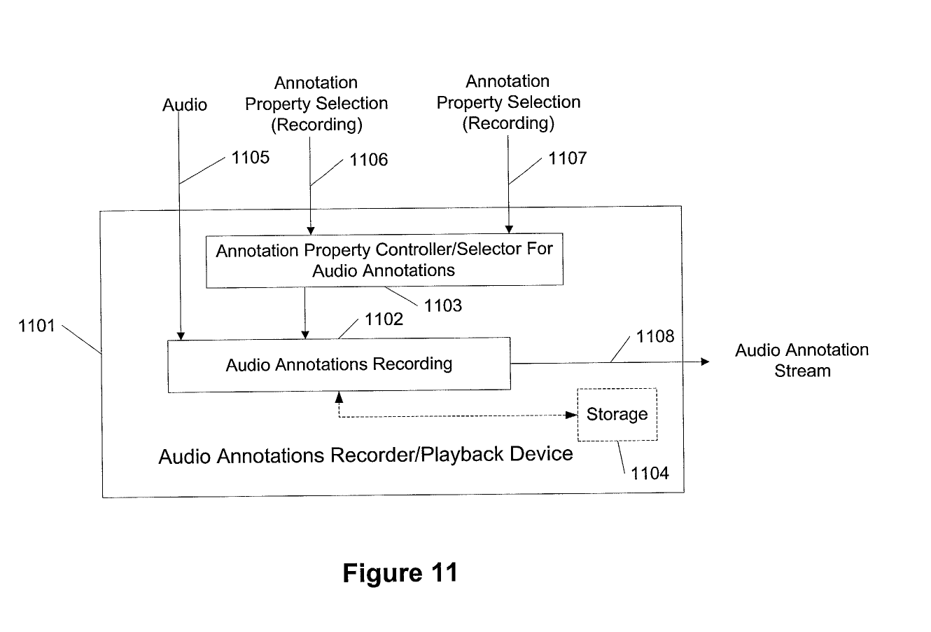

FIG. 11 is a block diagram of an audio annotation recorder/playback device in accordance with the present invention and includes a property controller/selector 1103 for selecting at least one property for audio annotations, coupled to an audio annotation recording unit 1102 that may include a storage unit, or alternatively, may use a separate storage unit 1104. The recording unit 1102 is also coupled to receive audio input. In one example, a property from section 1103 may be associated for recording audio. Then, the audio annotation recording unit 1102 records audio in accordance with the selected property/properties. To replay selected audio annotations, the user inputs at least one property, and the property controller/selector 1103 signals the audio annotation recording unit 1102 to output an audio annotation stream in accordance with the selected property/properties. It is noted that the device shown in FIG. 11 is an alternative to that shown in FIG. 1A.

Annotation Creation With Properties and Annotation Position

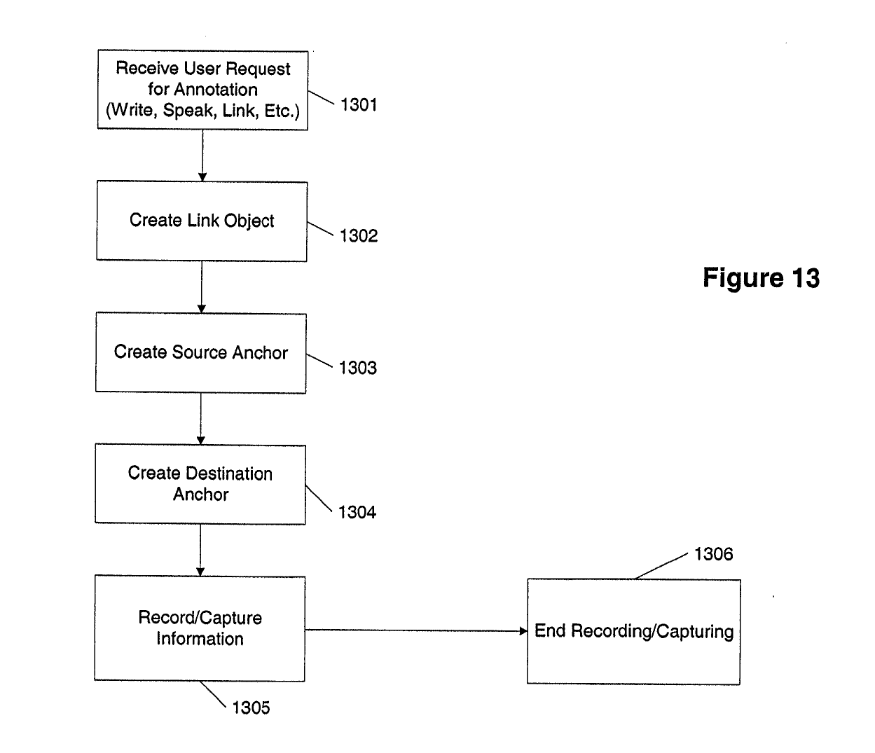

FIG. 13 describes a process for adding information to a document. First, in step 1301, the system receives a user request to add information. The user may want to add a written annotation (ink, highlights, underlining and the like) or add audio. This request may come in the form of speaking, tapping on a screen, writing on a screen, tapping a link, or the like. The system creates a link object in step 1302 to associate the information to be added with the document. In step 1303, the system adds information relating to the source document to the link object as the source anchor. The source anchor may including the name of the document, for example, “source document name=host doc 1”. The source anchor may include other properties as described above.

Next, in step 1304, the system adds information relating to the destination anchor to the link object. The destination information includes an identifier of the information to be added. In the case of a text note, the text note (note 15) may be referenced in the link object as “destination name=note 15”. Similar destination information may be used for ink, highlights, underlining and the like.

With respect to embedded audio notes, the following three steps occur:

1. A document representing the note is created;

2. A link is created between the place where the note icon is to appear (the source anchor for the link) and the newly created note document (the destination anchor); and,

3. If auto record is engaged, or if the user has manually opened the note and turned on recording, the focus is put on the note document so that newly recorded audio clips will be associated with the note document (this of course by virtue of property values set on the audio clips that reference the note document, e.g. “Note 15”).

For example, if the audio clips were being recorded and the current focus was host doc 1, the identification property of the audio clips would be set as “host doc 1”. If the focus was note 15, the identification property would be set to “note 15”. The link object also includes a behavior property that tells the system what to do when a specific link object is activated. In the case of audio information, the link object includes a behavior property to play audio clips. When activated, the system would play the audio clips having an identification property matching that contained in the destination anchor information of the link object.

In step 1305, the system records/captures the input information (records audio information or captures ink, highlighting, underlining and the like). Finally, in step 1306, the system ends recording/capturing and saves the recorded/captured information.

In reference to FIG. 13, it is noted that, if there are embedded notes on a page, one may tap on them to play back their contained audio (if any) or one may create and speak into new embedded notes. Here, the system simply changes what set of properties it is using to retrieve or store audio clips. As a result, one is free to create an embedded note that will contain both audio and text, or that will start out with text only at first and add audio to later, or that starts out as audio only and you add text too.

Annotation Playback With Page-Annotation Association

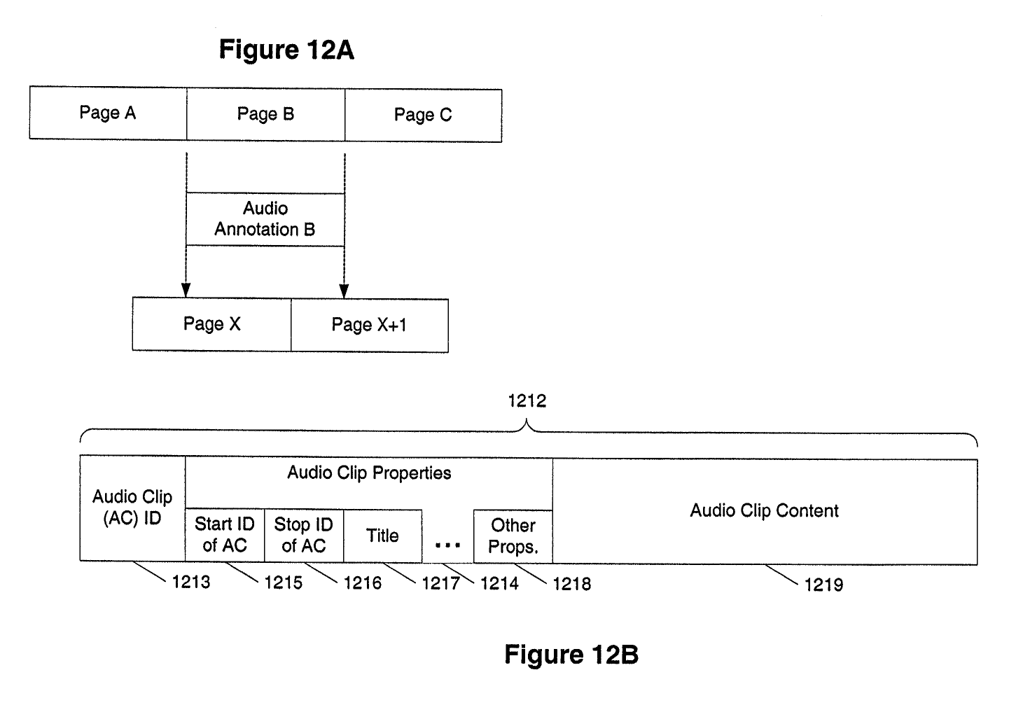

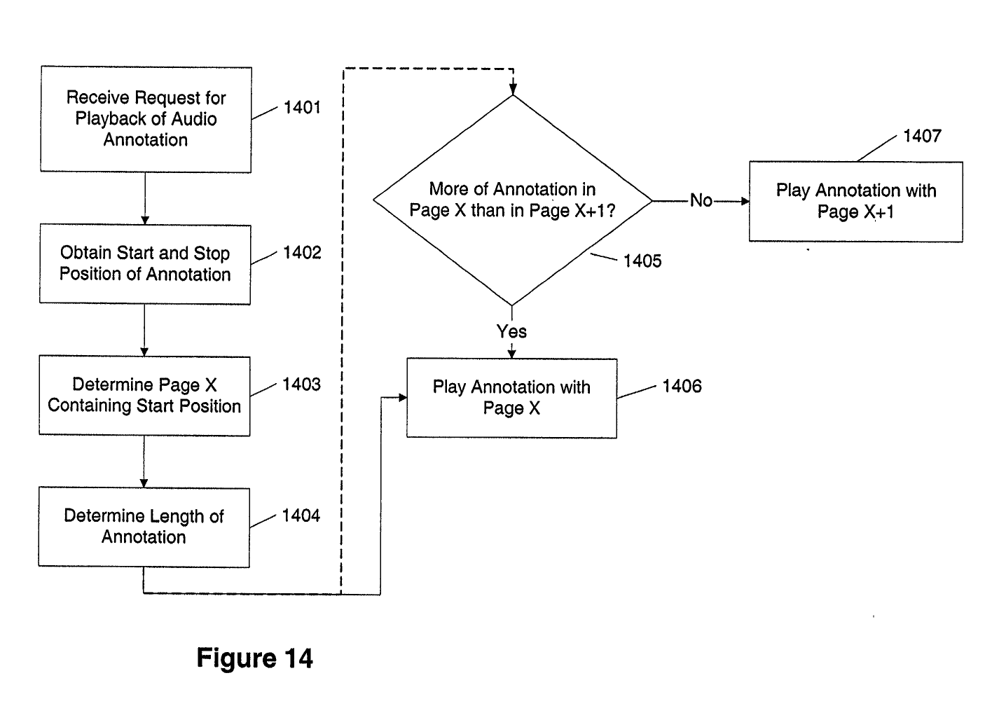

FIG. 14 shows a process for associating an audio clip with a page for playing. When an annotation relates to a page (for example, having been created in the automatic recording method), the system may determine which page best comports with the original page content as displayed when the audio clip was originally recorded. FIG. 12 shows a graphical representation of an audio annotation and new pages X and X+1. In step 1401 of FIG. 14, the system receives a request for playback of an audio annotation. In step 1402, the system obtains the start and stop positions identifiers (for example, the displayed page or file position of the first word on a page when a clip was recorded) associated with the audio clips. In step 1403, the system determines the currently rendered page having the starting position of annotation. The system determines the length of the annotation (step 1404). In a first embodiment, the system starts playing the annotation in step 1405 as associated with page X and lets the user advance the page manually when appropriate. The system may also determine to advance the page for the user when a certain percentage of the annotation has been played. The percentage may be fixed or adjustable based on various factors including how much of the annotation falls on page X and on page X+1.

In another embodiment, the system determines in step 1405 upon which page (X or X+1) more of the annotation falls (in step 1405). If more of the annotation falls in page X, then the system plays the annotation with page X displayed (step 1406). If more of the annotation falls in page X+1, the system plays the annotation with page X+1 displayed (step 1407).

FIG. 12A shows how the process of FIG. 14 may be implemented on pages three pages A, B, and C with audio annotation B having been captured while page B was displayed. In this example, the audio annotation B obtained the start and stop ids from page B. When audio annotation B is to be played, the system determines where start id falls in a given page X and compares the ratio of audio annotation B that falls in page X with that of page X+1.

Other embodiments exist. For example, instead of using the start position, the system may equally use the stop position of the annotation and work backward (e.g., page X and page X−1). Further, the system may obtain an intermediate position (between the start and stop positions) and attempt to determine which page (or pages) coincides with the page originally displayed while capturing the annotation.

FIG. 12B shows the data structure of an audio clip 1212. The audio clip 1212 includes a unique audio clip id 1213. It also includes properties 1214. Some of the properties may include the start id 1215 which contains the document position of the page on which the audio clip was initiated and the stop id 1216 which contains the document position of the page on which the audio clip was completed (these may be the same page). The start id 1215 and stop id 1216 of the page are useful in determining which page should a clip be associated with if the text has reflowed. FIGS. 14 details this process.

It is noted that, alternatively, only one of the start id 1215 and the stop id 1216 may be stored and/or used. For example, if the audio clips are short and would rarely, if ever, have a start id and a stop id separated by significant document positions (for example, more than one page), storing and using only one of the start id 1215 and stop id 1216 reduces the complexity of the audio clip data structure and reduces the storage space required for the audio clip.

The present invention may be implemented using computer-executable instructions for performing the steps of the method. The invention may be practiced on a computing device having the computer-executable instructions loaded on a computer-readable medium associated with the electronic device.

The present invention relates to a new way of treating the relationship of audio to a document. Storing audio as discrete clips with properties facilitates features that are part of this invention, like the ability to automatically synchronize document pages with audio playback and to index the audio recording by tapping on overlaid notes on the page. This design also simplifies the implementation of embedded audio notes.

Although the present invention has been described in relation to particular preferred embodiments thereof, many variations, equivalents, modifications and other uses will become apparent to those skilled in the art. It is preferred, therefore, that the present invention be limited not by the specific disclosure herein, but only by the appended claims.

We claim:

1. A system for receiving audio input comprising:
a display for displaying electronic information;
an audio input receiving audio content; and,
a processor for associating said received audio content with said displayed electronic information.

2. The system according to claim 1, wherein said audio content is in the form of audio clips.

3. The system according to claim 1, said processor further associating at least one property with said audio content and wherein said audio content is randomly accessible based on said at least one property.

4. The system according to claim 3, further comprising:
a storage for storing said audio content with said at least one property.

5. The system according to claim 1, further comprising:
an input receiving a user's input,
wherein said processor starts recording audio content from said audio input in response to said user's input.

6. The system according to claim 1, wherein said processor includes a voice activated recording system for recording said audio content.

7. The system according to claim 6, wherein said voice activated recording system records when said audio content exceeds a predetermined threshold.

8. The system according to claim 6, wherein said voice activated recording system records when a known user's voice is detected in said audio content.

9. The system according to claim 1, wherein said processor controls said display to indicate that audio content is associated with said displayed electronic information.

10. A system for playing audio content, said system comprising:
a display for displaying electronic information;
a storage for storing audio content, said audio content including properties and having been associated with said displayed electronic information;
an output for outputting at least some of said audio content with navigation of said displayed electronic information; and
a processor for controlling said display, said storage and said output.

11. The system according to claim 10, wherein said audio content are audio clips.

12. The system according to claim 10, wherein said audio content is randomly addressable based on said properties.

13. The system according to claim 12, wherein said storage is a database.

14. The system according to claim 10, further comprising:
an input for receiving a user's input,
wherein said output outputs at least some of said audio content in response to receiving said user's input.

15. The system according to claim 10, further comprising:
an input for receiving a user's input,
wherein said processor searches properties of said stored audio content in response to said user's input.

16. The system according to claim 15, wherein the output of said processor is sent to said display to display an indication of the search results.

17. The system according to claim 15, wherein the output of said controller is sent to the output for playing audio content with properties matching the search results.

18. The system according to claim 10, wherein said processor retrieves all audio content associated with said electronic information when said electronic information is accessed.

19. The system according to claim 10, wherein said processor outputs selected audio content to be played through said output when a page of said electronic information is displayed.

20. The system according to claim 19, wherein said processor automatically plays said selected audio content when said page is displayed.

21. The system according to claim 10, further comprising:
a communication link to transmit said audio content with its properties.

22. The system according to claim 21, further comprising:
a network connected to said communication link for receiving said audio content with properties, said network being accessible by other users.

23. The system according to claim 21, further comprising:
a receiving device of another user for receiving said audio content with properties, said receiving device receiving said audio content through one of a wired or wireless interface.

24. The system according to claim 22, wherein said network further processes said audio content.

25. The system according to claim 22, wherein said network includes a database for storing said audio content.

26. The system according to claim 22, wherein said network receives audio content without receiving said electronic information associated with said audio content.

27. A user interface for displaying electronic information to a user comprising:
a first display portion for displaying a portion of a document; and
a second display portion for displaying a graphical indication that said document includes an audio annotation associated with said displayed portion of said document.

28. The user interface according to claim 27, further comprising:
a third display portion for displaying a non-audio annotation.

29. The user interface according to claim 27, further comprising:
a third display portion for displaying an indication that said audio annotation is being recorded or played back.

30. The user interface according to claim 27, further comprising:
a third display portion for displaying one of a document tape or a master tape.

31. The user interface according to claim 27, further comprising:
a third display portion for receiving a user input of a property or properties of said audio annotation.

32. The user interface according to claim 27, wherein said audio annotation is recordable by said user.

33. A process for recording an audio annotation comprising the steps of:
displaying electronic information;
receiving a user input;
recording an audio annotation in response to said user input; and
associating said audio annotation with properties including a displayed portion of said electronic information.

34. The process according to claim 33, further comprising the step of:
storing said audio annotation prior to the association of said audio annotation with said displayed portion.

35. The process according to claim 33, further comprising the step of:
storing said audio annotation after the association of said audio annotation with said displayed portion.

36. The process according to claim 33, wherein said recording step records all ambient sounds.

37. The process according to claim 33, wherein said recording step records only sounds above a predetermined threshold.

38. The process according to claim 37, wherein said recording step records only a specific user's voice.

39. The process according to claim 33, further comprising the step of:
associating additional properties with said audio annotation at the start of recording of said audio annotation.

40. The process according to claim 33, wherein one of said properties is a file position or document position of an item on said displayed portion of said electronic information.

41. The process according to claim 33, wherein one of said properties is a start identification of said displayed portion of said electronic information.

42. The process according to claim 33, further comprising the steps of:
storing said audio annotation; and,
searching audio annotations including said audio annotation for at least one property matching a query.

43. A process for playing audio annotations comprising the steps of:
displaying a portion of electronic information;
receiving a user input;
retrieving audio annotations;
assembling said audio annotations into an audio stream; and
playing said audio stream.

44. The process according to claim 43, further comprising the step of:
waiting for a second user input prior to playing said audio stream.

45. The process according to claim 43, further comprising the step of:
playing once said audio stream is assembled.

46. The process according to claim 43, wherein said user input is a text query.

47. The process according to claim 43, wherein said user input is a voice query.

48. The process according to claim 43, further comprising the steps of:
altering the display of said portion to match a currently playing annotation in said audio stream.

49. The process according to claim 48, wherein said altering step includes the steps of:
comparing the length of said currently playing annotation with the starting identifications of displayable portions of said electronic information; and
displaying the portion of said electronic information supporting the greater length of said currently playing annotation.

50. A process for playing audio annotations comprising the steps of:
navigating to a page;
retrieving at least one audio annotation associated with a page or associated with an item on a page; and
playing said at least one audio annotation.

51. The process according to claim 50, further comprising the step of:
waiting for a user input prior to playing said audio annotation.

52. The process according to claim 50, wherein said item on said page includes at least one of embedded notes, inked notes, highlights and underlining.

53. The process according to claim 50, wherein said at least one audio annotation was previously retrieved and said retrieving step includes indexing said previously retrieved at least one audio annotation.

54. The process according to claim 50, wherein said at least one audio annotation is the result of a newly executed query.

55. A computer readable medium having a data structure stored thereon, said data structure comprising:
a document;
a link object; and
audio content with at least one property,
wherein said link object references said document and references said audio content.

56. The data structure according to claim 55, wherein said property relates to the time said audio content started recording.

57. The data structure according to claim 55, wherein said property relates to the time said audio content stopped recording.

58. The data structure according to claim 55, wherein said property relates to the length of recording of said audio content.

59. The data structure according to claim 55, wherein said property relates to the author of the recording.

60. The data structure according to claim 55, wherein said property relates to the start ID.

61. The data structure according to claim 55, wherein said property relates to the stop ID.

62. The data structure according to claim 55, wherein said audio content is comprised of a plurality of audio clips.

63. The data structure according to claim 62, wherein said audio clips are stored in a database.

64. The data structure according to claim 55, wherein said property is one of plurality of properties and said properties are in a marked up language form.

65. The data structure according to claim 64, wherein said properties are in XML.

66. The data structure according to claim 55, wherein said audio content is stored within a document.

67. The data structure according to claim 55, wherein said audio content is stored apart from a document.

68. The data structure according to claim 67, wherein said audio content is stored in a database with at least one property designating the position of viewed document relating to said audio content.

69. The data structure according to claim 67, wherein said audio content is stored in a database and linked to a separate annotation document that stores the position of a viewed document relating to said audio content.

70. A process for recording audio content comprising the steps of:
navigating to a page of a document;
recording said audio content; and
associating properties with said audio content such that retrieval of said audio content positions said audio content after previously recorded audio content.

71. The process according to claim 70, wherein said audio content comprises audio clips and wherein said associating step includes a time property.

72. The process according to claim 71, wherein said audio content and said previously recorded audio content is ordered at least by said time property.

73. A process of searching audio clips comprising the steps of:
inputting search terms or properties;
searching said audio clips for said search terms or properties; and
ordering audio clips detected by said searching step for output.

74. The process according to claim 73, wherein said inputting step further comprises the steps of:
receiving verbally delimited keywords; and
converting said verbally delimited keywords into search terms or properties.

75. A process for recording audio information comprising the steps of:
recording audio signals as a first file;
processing said file to extract audio clips; and
storing said audio clips,
wherein said processing separates the content of said first file into audio clips based on events.

76. The process for recording according to claim 75,
wherein said audio signals include speech, and
wherein said events comprise at least one of short pauses in said speech, a pause of a predetermined length, and a user navigating away from a displayed page.

77. A process for associating audio notes and handwritten notes comprising the steps of:
creating a handwritten note;
associating a time at which said handwritten note was created with said handwritten note;
creating an audio note; and
associating a time at which said audio note was created with said audio note,
wherein, upon selection of said handwritten note, audio notes recorded at or near the time at which said handwritten note was created are located.

78. The process according to claim 77, wherein locating said audio notes includes the step of querying a database for audio clips.

79. The process according to claim 77, wherein locating said audio notes includes the step of searching a table.

80. The process according to claim 77, wherein locating said audio notes includes the step of searching a linked list.

81. The process of claim 77, wherein said audio notes are comprised of audio clips in which each audio clip has a time of creation associated with each audio clip.

82. The process according to claim 77, further comprising the step of:
playing said audio notes.

83. A process for playing audio notes comprising the steps of:
displaying a first page of electronic information;
playing audio notes associated with said first page;
displaying a second page of electronic information; and, playing audio notes associated with said second page.

84. The process according to claim 83, further comprising the step of receiving user input,
wherein, in response to said user input, said second page is displayed.

85. A process of recording audio notes comprising the steps of:
displaying a first page of electronic information;
recording a first set of audio notes;
associating said first set of audio notes with said first page;
displaying a second page of electronic information;
recording a second set of audio notes; and
associating said second set of audio notes with said second page.

86. The process according to claim 85, further comprising the step of receiving user input,
wherein, in response to said user input, said second page is displayed.

87. A process for editing audio notes comprising the steps of:
querying a database for audio information;
ordering said audio information into audio notes; and
performing editing features on said audio notes.

88. The process for editing audio notes according to claim 87, wherein said editing comprises at least one of the steps of:
adding audio information;
deleting audio information; and
overwriting existing audio information.
